(19) United States
(12) Patent Application Publication
(10) Pub. No.: US 2025/0378729 A1
(43) Pub. Date: Dec. 11, 2025

(54) UNATTENDED POINT OF SALE DEVICE FOR ENABLING CONNECTED DEVICES

(71) Applicant: J.J. MacKay Canada Limited, New Glasgow (CA)

(72) Inventors: James George MacKay, Frasers Mountain (CA); Adrian Ignatius O'Neil, New Glasgow (CA); Allan Wade Macdonald, Dartmouth (CA); Ronald Vincent Lank, New Glasgow (CA); Darren Scott Cameron, New Glasgow (CA)

(73) Assignee: J.J. MacKay Canada Limited, New Glasgow (CA)

(21) Appl. No.: 19/232,305

(22) Filed: Jun. 9, 2025

(30) Foreign Application Priority Data
Jun. 6, 2024 (CA) 3240700

(51) Int. Cl. G07F 17/00; H04L 67/12

(52) U.S. Cl. CPC G07F 17/0021; H04L 67/12

(57) ABSTRACT

An unattended point of sale (POS) device for metering usage of an external device may include a display, a keypad, a payment device, an external interface connected to the external device, a power component for powering the POS device, control functionality for controlling the POS device and metering devices, and an external housing securable at a location in proximity to the external device to protect the unattended POS device from environmental conditions and vandal attacks. The control functionality may display purchase options for using the external device, receive from the keypad desired usage of the external device, receive payment information from the payment device, transmit enabling information to enable usage of the external device, update the display with purchased usage information, determine if purchased usage has expired, and transmit disabling information to disable usage of the external device upon expiry of purchased usage.

### CROSS-REFERENCE TO RELATED APPLICATION

The present application claims priority from Canadian Patent Application No. 3,240,700, filed on Jun. 6, 2024, the disclosure of which is incorporated herein by reference in its entirety.

### TECHNICAL FIELD

The current disclosure relates to unattended point of sale terminals/devices and in particular to unattended point of sale devices that can control various connected devices.

### BACKGROUND

Various devices may be provided for use by members of the public in unattended locations. For example, at gas stations or convenience stores, a vacuum may be provided that allows a user to clean their vehicle, or an air pump that allows the user to inflate tires or other devices. Such devices may allow a user to make payment, for example using coins or other payment means, in order to use the device for a period of time.

While such devices can provide a useful service in unattended locations, their design can make it difficult to incorporate new features into the device's operation.

An additional, alternative and/or improved device for controlling connected devices is desirable.

### BRIEF DESCRIPTION OF THE DRAWINGS

Further features and advantages of the present disclosure will become apparent from the following detailed description, taken in combination with the appended drawings, in which:

FIG. 1 depicts an unattended point-of-sale (POS) device controlling externally connected devices;

FIG. 2 depicts further details of the unattended POS device and externally connected devices;

FIG. 3 depicts a further unattended POS device and externally connected devices;

FIG. 4 depicts a further unattended POS device and externally connected device;

FIG. 5 depicts a further unattended POS device and externally connected device;

FIG. 6 depicts a portion of the POS device housing and mounting structure;

FIG. 7 depicts a system for managing unattended POS devices and devices;

FIG. 8 depicts a method of controlling externally connected devices by an unattended POS device and illustrative display screens; and

FIG. 9 depicts a further illustrative display screen.

### DETAILED DESCRIPTION

In accordance with the present disclosure, there is provided an unattended point of sale (POS) device for metering usage of an external device comprising: a display; a keypad; a payment device; an external interface connected to the external device; a power component for powering the POS device; at least one processor and memory providing control functionality for controlling the POS device and metering devices, the control functionality comprising displaying on the display purchase options for using the external device, receiving from the keypad an indication of the desire to use the external device, receiving payment information from the payment device, transmitting enabling information over the external interface to enable usage of the external device, updating the display to display purchased usage information, determining if the purchased usage of the external device has expired, and when the purchased usage of the external device has expired, transmitting disabling information over the external interface to disable usage of the external device; and, an external housing securable at a location in proximity to the external device to protect the unattended POS device from environmental conditions and vandal attacks.

In a further embodiment of the POS device, the payment device comprises one or more of: a card reader; a coin discriminator; an NFC reader; and functionality for determining payment from a received code.

In a further embodiment of the POS device, the external interface comprises a physical connector for establishing a wired connection to the external device.

In a further embodiment of the POS device, the physical connector provides a data channel.

In a further embodiment of the POS device, the physical connector provides a power connection.

In a further embodiment of the POS device, the power component receives power from the external device over the power connection of the physical connector.

In a further embodiment of the POS device, the external device receives power from the POS device over the power connection of the physical connector.

In a further embodiment of the POS device, the power component comprises a battery housed within external housing.

In a further embodiment of the POS device, the POS device further comprises a solar panel for recharging the battery.

In a further embodiment of the POS device, the control functionality allows the POS device to control a plurality of external devices.

In a further embodiment of the POS device, the plurality of external devices are arranged for use by different users simultaneously.

In a further embodiment of the POS device, the plurality of external devices are arranged for use by a single user.

In a further embodiment of the POS device, the external device comprises one or more of: an air pressure device; a vacuum device; a charging device; a car wash device; an electric vehicle charging device or supply equipment; a potable water dispenser device; a windshield washer fluid dispenser device; a newspaper dispenser device; a lighting control device; and a sports facilities control device.

In a further embodiment of the POS device, the keypad comprises one or more of: an alpha-numeric keypad; a six button keypad; and a four button keypad.

In a further embodiment of the POS device, the display comprises a touch screen display.

In a further embodiment of the POS device, the keypad comprises a keypad screen displayed on the touch screen display.

Devices such as vacuums and air pumps for tire inflation may be arranged at exterior locations for unattended use by individuals. Such devices may require payment for their use. For example, a car cleaning vacuum may require $2.50 to use the vacuum for 5 minutes. The devices may be located in areas for unattended use. Such unattended devices require protection from both the external environment as well as possible vandal, or theft, attacks. As described further herein, the metering functionality can be provided by a robust metering head intended for unattended operation that is connected to the devices in order to control their operation. The control of the external devices may comprise enabling, or turning on, a device such as a pump, motor, relay, etc. and disabling, or turning off, the device. The metering head provides an unattended POS device that can perform the metering functionality as well as enabling/disabling the connected devices as appropriate. The POS device may also monitor a second signal line that acts as a feedback or sensing line from the external device(s) that acts as a control signal to deactivate or turn off the external device(s).

The POS device may also accept payment for operating the devices. The accepted payments may include for example, coins, bills, debit cards, credit cards, stored-value cards, NFC devices, and pre-authorized codes or accounts. The POS device may include one or more radios for communicating with external devices, including payment systems, as well as management systems, such as for example a remote cloud-based management system, that can monitor, control and manage one or multiple POS devices.

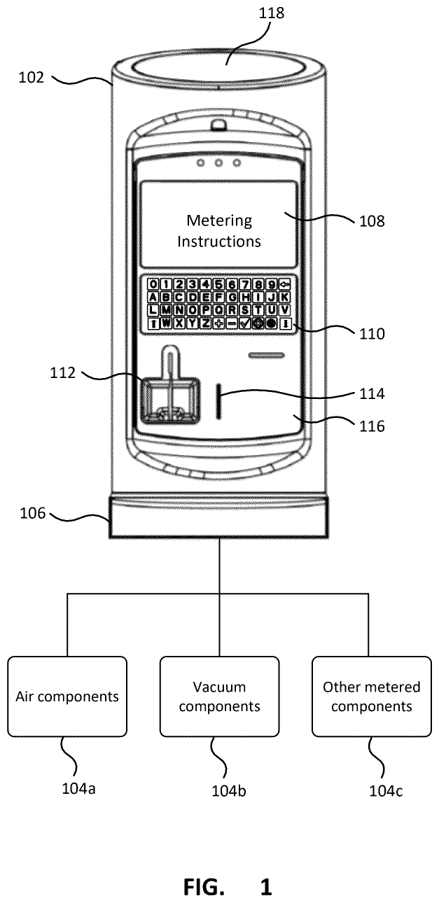

FIG. 1 depicts an unattended point-of-sale (POS) device controlling externally connected devices. The POS device 102 provides payment and metering functionality for use in controlling one or more connected device components. The device components may include air components 104a such as components for inflating tires or other devices, vacuum components 104b providing a cleaning vacuuming and other metered components 104c that may provide various functionality for a period of time, including for example, cleaning devices, etc. The various external device components 104a, 104b and 104c may be referred to collectively as external devices 104. The external devices controlled by the POS device may be existing external devices that can be retrofitted to be controlled by the POS device, or may be new external devices installed with, or after, the POS device.

The POS device 102 comprises an external housing that encloses the operating components and provides protection to the components against the environment as well as providing protection against vandal and theft attacks. The housing may be formed from a high strength plastic material, metal and/or combinations of metal and plastics.

The housing may be secured at the location directly to an object or device, or may be secured indirectly through one or more intermediary connectors 106. The intermediary connector 106 allows the POS device 102 to be secured to various objects or devices without compromising the housing or exposing portions of the POS device that could be susceptible to a vandal's attack, such as openings for passing cables.

The intermediary connector 106 may be connected to the POS device 102 as well secured to a portion of the external device being controlled. Alternatively, the intermediary connector, and the POS device, may be secured in proximity to the external device being controlled. For example, the POS device may be secured to a pole, box, wall, etc. in the vicinity of the external device being controlled.

The housing provides areas that are accessible to the user for a display 108 and keypad 110. The keypad 110 is depicted as a 44 button alpha-numeric keypad that includes keys for digits 0-9, keys for letters A-Z, a delete key, arrow keys, and keys for “+” and “−”. An “OK” key, a “Cancel” key, and/or a home or settings key may also be provided. It will be appreciated that while depicted as a 44 button keypad, other embodiments with additional or fewer keys are possible. For example, the numbers and/or letters may be omitted or additional special character function keys may be included. Further, a 6 button keypad may be provided that includes left and right arrow keys, keys for “+” and “−”, an “OK” key, and a “Cancel” key. Further a 4 button keypad may be provided that includes keys for “+” and “−”, an “OK” key, and a “Cancel” key. Although the keypad 110 is depicted as being separate from the display 108, it will be appreciated that if the display is a touch screen, the keypad may be provided as a keypad screen displayed on the touch screen display. It will also be appreciated that the number of keys may be varied from the examples herein, whether the keypad is a physical keypad or a keypad screen displayed on the touch screen display.

The housing may also provide user accessible areas for optional payment devices, including a card reader 112, coin slot 114, and contactless ‘Tap’ reader 116. Other types of payment may be accepted as well such as using a coupon code, or account code that can be associated with a pre-payment amount, or may be paid on a periodic basis such as every day, week or month, when a balance exceeds a set amount, etc. The coupon or account code may be entered using the keypad 110. Additionally or alternatively, license plate numbers or account numbers associated with accounts where the account owner has pre-paid to use an external device may be entered using the keypad 110. For example, an account owner may own or operate a fleet of vehicles, and pre-pay for use of external devices located in one or more locations. Additionally, although not depicted in FIG. 1, payment information, which may specify a payment account, authorization code or coupon, may be provided to the POS device in other ways such as over a Bluetooth communication channel or received over a WiFi or cellular network. For example, a user may pay to use the device using an app on their mobile device which may then communicate an authorization code to the POS device over Bluetooth. Additionally or alternatively, a backend server may communicate the payment to the POS device.

Depending upon the installation, the POS device may be powered by an internal battery, from one or more of the external devices 104, or from 3rd party power equipment. If the POS device is powered by an internal battery, the POS device may include one or more solar panels 118 for charging the internal battery. If the connected external device or devices do not have significant power requirements to operate, the external device or devices can be powered from the POS device. Whether or not the external device is considered to use significant power will depend on a number of factors including, how much power the device uses, how often the device is used, the size of the internal battery, the solar power generation capabilities of the POS device, as well as the power requirements for the POS device. An external device would be considered to use significant power if it was likely to drain the internal battery during operation, before the battery could be recharged, to a level that would render the external device and/or the POS device inoperable.

The POS device may be located in area where power can be supplied to it, either in the form of a power source, such as provided from the power grid, a generator, solar panels, wind generators or other power sources. The power sources may be an AC or DC power source. The POS device may include power regulation components for regulating and converting the power from the power source to the appropriate levels, such as DC 12 Vs, 5 Vs, etc. The POS device may supply the power to the connected external devices 104. The power source may be provided from one or more of the external connected devices if they are powered from a power source.

The unattended POS device depicted in FIG. 1 provides a flexible POS device that can be used in unattended locations to provide the payment and metering functionality for one or more pieces of equipment that can be controlled by the POS device. The POS device may use various communication methods for communicating and controlling the equipment of the external devices. The specific command and control communication protocols may be adjusted based on the particular equipment requirements.

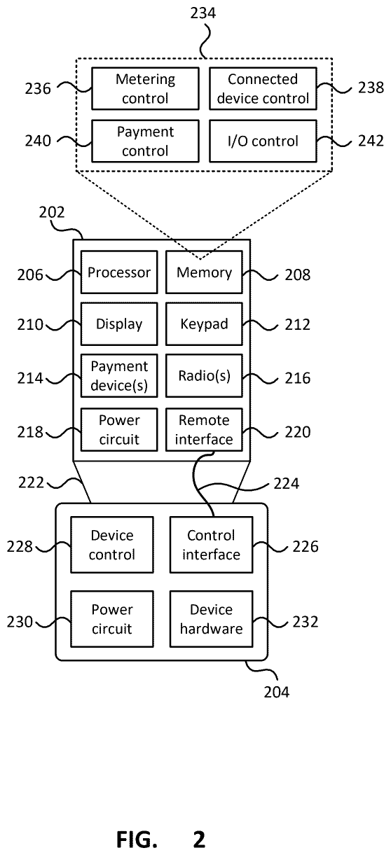

FIG. 2 depicts further details of the unattended POS device and externally connected devices. As depicted in FIG. 2, a POS device 202 may be mounted to, or in the general vicinity of, an external device 204 that is controlled by the POS device. The POS device includes at least one processor 206 and associated memory 208. The at least one processor and memory store and execute instructions in order to perform various functionality. The POS device 202 further includes a display 210 and keypad 212 for interacting with users. Although depicted as separate components, the keypad and display may be combined together in a touch screen display. Further, additional components may be provided such as speakers, lights etc. for communicating information to users or other individuals.

The POS device may also include one or more payment devices 214. The payment devices receive payment information which can be used by the POS device to receive payment for the usage of the associated devices. The payment devices may include, for example, a coin discriminator that allow a user to deposit one or more coins and determine the value of the coins. Further, the payment device may include a cash reader. Further payment devices are possible including for example a card reader that can read magnetic strip cards and/or chip-based payment cards. The payment devices may further include contactless payment ‘tap’ readers that can read payment information from cards, devices or tags that utilize Near-Field Communications (NFC) technology. The payment information received from the payment devices, or by other means, such as possibly entered manually by a user or communicated to the POS device in other means, can be used to make the payment, or determine that the user is otherwise authorized to use the device. For example, a user, group of users, company, etc. may have an agreement to allow the use of the device without further payment. Further, the payment information may be used by the POS device to verify the user is able to use the external device. The verification may be performed at the POS device, or the payment information may be communicated from the POS device to a remote server in order to verify the authorization to use the device, which may include the remote server completing payment for the usage.

The POS device 202 may further include one or more communication radios 216, which may be wired or wireless. The wireless radios may allow the POS device to communicate with other devices. The wireless radios may include Bluetooth™ radios, Zigbee™ radios, or other short range communication radios. The communication radios may further include longer range communication radios such as WiFi™ radios, and/or cellular radios. The communication radios allow the POS device 202 to communicate with various devices, including for example user devices such as mobile phones, remote servers providing payment functionality, and/or management functionality.

The POS device 202 further includes one or more power circuits 218 for powering the POS device 202. The power circuit 218 may include an internal battery and/or a solar panel for powering the POS device 202. Additionally, or alternatively, the power circuit 218 may comprise one or more regulators that receive power from an external source and regulate the power to be suitable for the POS device. For example, the external power source may supply DC power at a voltage that is too high, or too low, for the POS device and the power circuit can regulate the supplied voltage to the desired level for the POS device. Further, the external power source may supply AC power to the POS device and the power circuit may convert the AC power to DC power and regulate the DC power to the desired voltage. The external power source supplying power to the POS device may be the external device or it may be another source.

The POS device further includes one or more remote interfaces 220 that allow the POS device to control the external device 204. The remote interfaces 220 may include one or more types of communication interfaces including for example serial communication protocols such as a simple RX/TX serial TTL/RS232 interface, a full serial RS232/TTL interface with handshake control, or a serial SPI interface with the POS device set up as host. The POS device can also support an RS422 or RS485 driver circuit to allow for higher baud rates and greater distances between the POS device and the external device. In such an arrangement, the POS device can be configured with an expanded command and response protocol that includes specific equipment addressing and identification such that a single POS device can effectively communicate with multiple external devices. Other remote interfaces may be used to allow the POS device 202 to control the external device 204. In addition to the communication interface, the remote interface between the POS device 202 and external device 204 may include connections for providing power either from the external device to the POS device, or from the POS device to the external device. Further, the POS device can be configured to adhere to standard protocols such as OCCP (Open Charge Point Protocol) and OpenADR in addition to other proprietary protocols to facilitate the control of as well as the reporting of information related to the external devices.

The POS device may be mounted to the external device, or other structure in the vicinity of the external device, by an intermediary mounting connector 222. When the POS device is connected to the external device using one or more wires 224, the wires may be securely routed through the intermediary mounting connector 222 to the external device. Although depicted as a direct connection, the connection may pass through one or more conduits to protect the connection if it is exposed between the POS device and the external device.

The external device 204 includes a control interface 226 that allows the remote interface 220 of the POS device to control, monitor and/or communicate with the external device. The control interface may correspond to the remote interface 220 of the POS device. The external device 204 includes device control functionality 228 that can control the external device based on the commands, etc. received from the POS device received over the control interface 226. The external device may include a power circuit 230 for powering the external device, and possibly the POS device. The power circuit 230 may receive power from an external source and convert and/or regulate the received power to the power required by the external device. The external device includes the device hardware 232 that provides the particular functionality of the external device. The device hardware may include for example pneumatic equipment such as an air pump, a vacuum, etc. The device hardware may additionally or alternatively comprise hydraulic or fluidic equipment. The particular device hardware may vary and provide a range of functionality that users may be interested in that can be metered and controlled by the POS device. For example, in the case of an air compressor used to inflate tires, the air compressor may automatically stop the inflation once a set pressure is reached. The control provided by the POS device may set a desired pressure target and turn on the compressor, which will inflate the tire until the set pressure is reached, or until the POS device turns off the compressor once the purchased time expires. Alternatively, the POS device may turn on the compressor and continually check the pressure and turn the compressor off once the desired pressure is reached, or if a set length of time is passed.

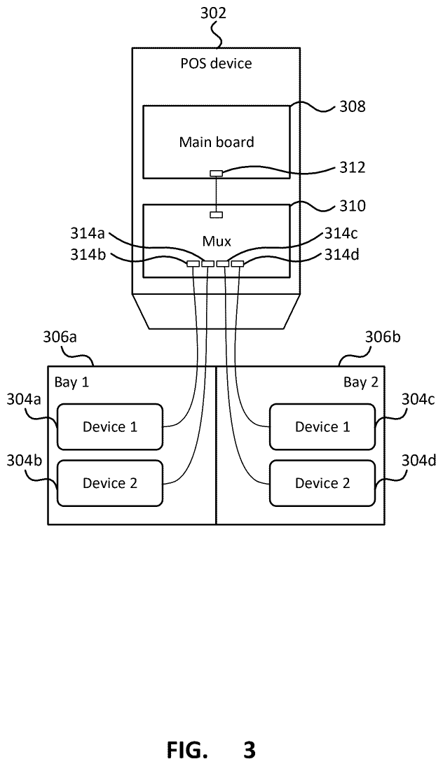

FIG. 3 depicts a further unattended POS device and externally connected devices. The POS device 302 is depicted as controlling a plurality of separate external devices 304a, 304b, 304c, 304d (referred to collectively as external devices 304). The external devices 304 may be arranged in different areas depicted as bays 306a, 306b. As an example, the devices may comprise an air compressor and a vacuum in a first car bay and another air compressor and vacuum in a second car bay. The POS device may comprise a main board 308 which may include one or more ports that can be used to connect to the external devices. However, as depicted, if the number of external devices 304 exceeds the number of available ports on the main board, a multiplexer board 310 may be fit within the housing of the POS device. The multiplexer board can be connected to a single port 312 of the main board and may expand the number of ports 314a, 314b, 314c, 314d in order to allow each of the individual external devices to be connected. As depicted, the multiplexer board may be used in order to allow a single POS device to be physically connected to a plurality of external devices 304. Although the multiplexer board is depicted as multiplexing connections to external devices, it may also multiplex connections to internal devices such as to the payment devices.

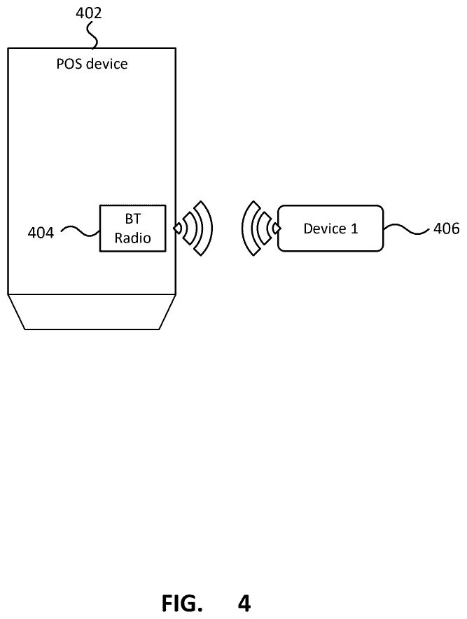

FIG. 4 depicts a further unattended POS device and externally connected device. The above has described the POS device as being physically connected to the external devices being metered and controlled by the POS device. As depicted in FIG. 4, a POS device 402 may include a Bluetooth radio 404 for remotely communicating with an external device 406. The external device 406 may be controlled by the POS device 402 using commands communicated over the Bluetooth radio. Although described as using a wireless Bluetooth radio to wirelessly meter and control the external device, other wireless communication radios, protocols or means (e.g., infrared) may be used. Further, although depicted as controlling a single external device, it is possible that the wireless radio (or other communication means) may be used by the POS device to meter and control a plurality of external devices.

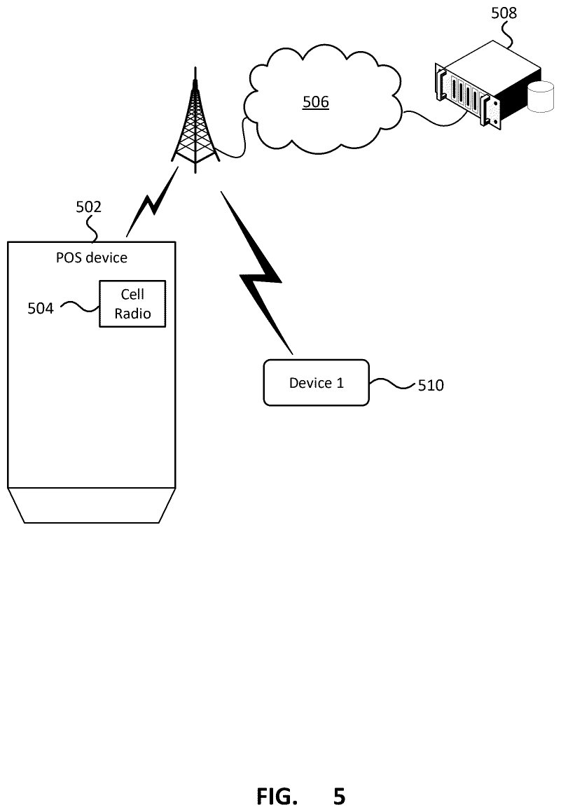

FIG. 5 depicts a further unattended POS device and externally connected device. As described above with reference to FIG. 4, it is possible for the POS device to wirelessly meter, monitor and control an external device. However, in FIG. 4 it was described that the POS device communicates directly with the external device. As described with reference to FIG. 5, it is possible for the POS device to indirectly meter and control the external device. The POS device 502 may include a cellular radio that can communicate over a cellular network 506 to a remote server 508. The remote server may provide control and/or management functionality for the external device 510. The POS device 502 may communicate the metering and control commands for the external device to the remote server 508, which may communicate the control commands to the external device 510 over the communication network. Although the communication between the POS device and the remote server and between the remote server and external device are depicted as being made over the same communication network, different communication networks, and communication technologies, may be used for each portion of the communication. Further, although depicted as communicating with a single external device, the POS device 502 may meter and control a plurality of external devices via the remote server 508.

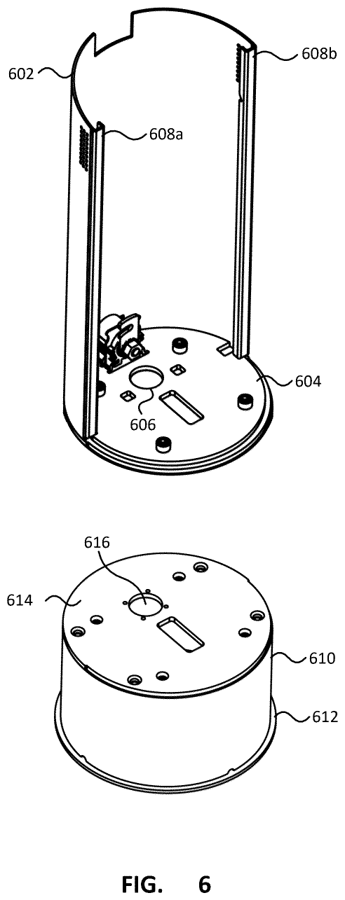

FIG. 6 depicts a portion of the POS device housing and mounting structure. The above has described various POS devices that may be mounted to, or in the vicinity of, an external device that the POS device meters and controls. The POS device includes a housing that protects the POS device components from an external environment and/or vandal attacks. The housing allows the POS device to be secured at the desired location. It is noted that FIG. 6 omits the front portion of the POS device to which the components are attached. The portion of the housing depicted in FIG. 6 includes a back housing 602 that is attached to, or formed with, a base plate 604. The base plate 604 has one or more openings including an opening 606 that allows one or more cables or wires to pass through. The back housing includes a pair of vertically extending rails 608a, 608b that engage with the front portion to allow the front portion to slide down and be secured to the back housing.

In addition to the back housing 602, an intermediary connector housing 610 is provided that can facilitate securing the back housing of the POS device at the desired location. The intermediary connector 610 includes a base portion 612 that is adapted to securely mate and be mounted to an object or structure at the location. The particular shape of the base portion may vary depending upon the structure the POS device is being secured to. The intermediary connector housing 610 includes a top plate 614 that matches the bottom plate 604 of the back housing 602 and includes a cutout 616 for cables or wires to pass through. The cutout 616 may match the opening 606 of base plate 604. In order to allow the cables running between the POS device and external device to be easily connected/disconnected if the POS device needs to be replaced, the cutout 616 may include a cable or wire connector/junction at or around cutout 616. The intermediary connector housing 610 provides a transition between the base plate 604 of the back housing 602 of the POS device and the surface that the POS device is being mounted to, which can provide greater flexibility in the mounting options for the POS device.

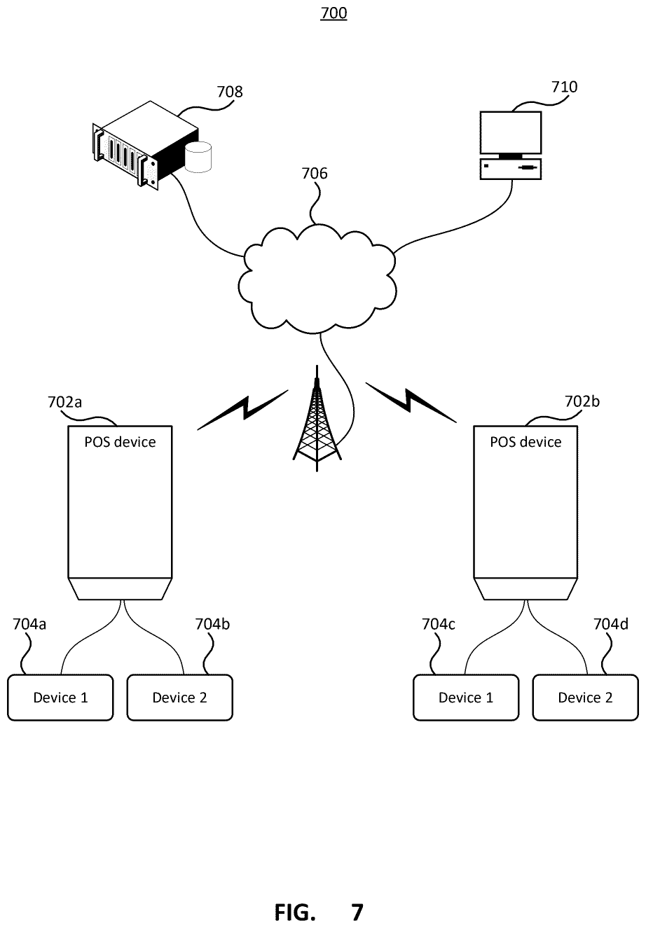

FIG. 7 depicts a system for managing unattended a POS device and POS devices. The above has described individual POS devices for metering and controlling one or more external devices. As depicted in FIG. 7, a system 700 may be provided for managing a plurality of different POS devices 702a, 702b (referred to collectively as POS devices 702). As depicted, each of the POS devices 702 may each control one or more respective external devices 704a, 704b, 704c, 704d (referred to collectively as external devices 704). Each of the external devices may communicate over a communication network 706 with a remote backend management server 708. The management server 708 may monitor and control the plurality of POS devices 702, including for example setting costs for purchasing amount of time, setting and/or updating display screens, device settings, updating POS device firmware, updating external device firmware, etc. Further, the management server 708 may also determine usage and status information from the POS devices 702. The usage and status information may provide an indication of the usage as well as the serviceability of the POS devices 702 and external devices 704, including an amount of money received, an amount of time the devices have been used, any errors that occurred, if a payment device is jammed, or has abnormally low usage, if the POS device has failed to regularly communicate with the remote management server, etc. The management server 708 may be accessed by one or more computing devices 710. For example, the computing device 710 may be used by a manager or other individual to review and/or modify the settings of POS devices, review usage information, etc.

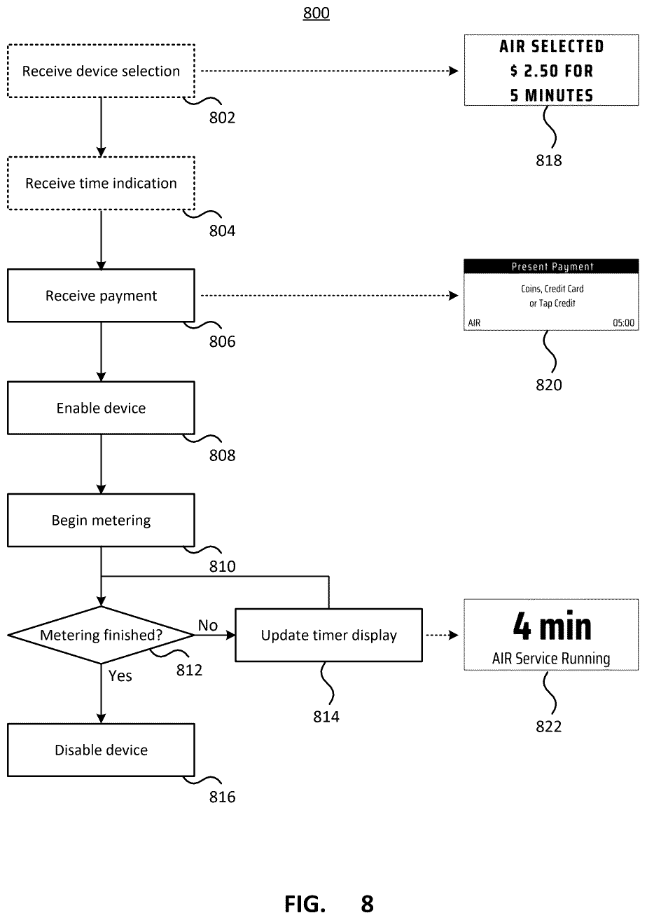

FIG. 8 depicts a method of controlling externally connected devices by an unattended POS device and illustrative display screens. The method 800 receives a device selection indicative of the external device to be metered and controlled. If the POS device only meters and controls a single external device, the device selection may be omitted, or made automatically. Similarly, a time indication is received (804), indicating how long a user wished to use the external device for. If the external device is only able to be operated for a fixed period of time, say 5 minutes, the selection of the time may be omitted or made automatically. Payment is received for the time (806). The payment may be made in various ways, including by inserting coins, using a payment card, entering a code, etc. The payment may also be used to provide a time indication. For example, if paying by coins, the amount of time may be set based on the amount of coins inserted. Once payment is made, the external device is enabled (808) for the purchased period of time and the POS device begins metering the purchased time (810). The POS device may periodically check the metering functionality to determine if the metering is finished (812) and if it is not (No at 812) the POS device's display may be updated to reflect an amount of purchased time remaining. If the metering is complete (Yes at 812), the POS device may then disable to the device (816).

FIG. 8 depicts illustrative display screens 818, 820, 822 that can be displayed to the user throughout different portions of the process. As depicted, a screen may indicate which of the available services has been selected along with payment information indicating the cost for purchasing time using the service. Once the service, and possibly desired amount of time is selected, a payment screen 820 may be presented providing instructions for providing the payment. Once payment is made and use of the service has started, the screen may be updated to reflect the amount of purchased time remaining 822. Once the purchased time has expired a screen may be displayed indicating that the time has expired or other message. It will be appreciated that the screens depicted in FIG. 8 are only illustrative of the process and other screens may be presented to the user.

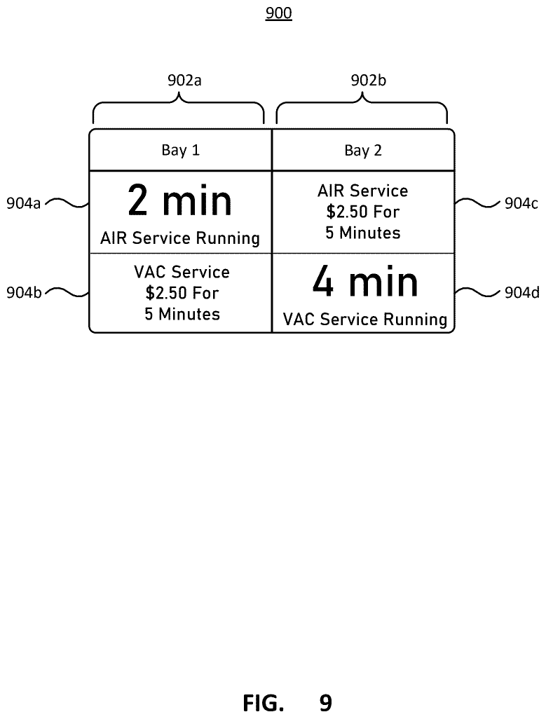

FIG. 9 depicts a further illustrative display screen. The screens depicted above with reference to FIG. 8 were depicted with regard to metering and control of a single external device. As described above, it is possible for a single POS device to control multiple external devices, possibly grouped together in different usage locations. An illustrative screen 900 that may be used in such applications is depicted in FIG. 9. The screen may include different sections for each usage location, described as bay 1 902a and bay 2 902b. Each of the usage location sections 902a, 902b may present the external device location information for each of the devices arranged at the respective locations. In bay 1, it is depicted by screen portion 904a that the air service is currently running and has 2 minutes remaining, while the screen portion 904b depicts that the vac service is not currently running but can be purchased for $2.50 for 5 minutes. Similarly, for the devices in bay 2, the screen portion 904c depicts that the air service is not running but can be purchased for $2.50 for 5 minutes, while screen portion 904d depicts that the vac service is running and has 4 minutes remaining. Various other screens may be presented to the user in order to purchase time for specific external devices. It will be appreciated that the arrangements of devices within bays and across bays may be mixed and matched as may be desired (e.g., air service or vac service only in one bay, versus mixing air service and vac service within a bay, etc.).

In addition to the air and vacuum external devices described above, other external devices may additionally or alternatively be connected to the POS device. Such other external devices include car wash stations, electric vehicle charging stations, electric vehicle supply equipment (EVSE), potable water dispensers, windshield washer fluid dispensers, newspaper dispensers, and lighting and other control systems for public and/or sports facilities (e.g., outdoor tennis courts, pickle ball courts, rinks, batting cages, etc.).

It will be appreciated by one of ordinary skill in the art that the system and components shown in FIGS. 1-9 may include components and/or steps not shown in the drawings. For simplicity and clarity of the illustration, elements in the figures are not necessarily to scale, are only schematic and are non-limiting of the elements' structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. An unattended point of sale (POS) device for metering usage of an external device comprising:
a display;
a keypad;
a payment device;
an external interface connected to the external device;
a power component for powering the POS device;
at least one processor and memory providing control functionality for controlling the POS device and metering devices, the control functionality comprising:
displaying on the display purchase options for using the external device;
receiving from the keypad an indication of the desire to use the external device;
receiving payment information from the payment device;
transmitting enabling information over the external interface to enable usage of the external device;
updating the display to display purchased usage information;
determining if the purchased usage of the external device has expired; and
when the purchased usage of the external device has expired, transmitting disabling information over the external interface to disable usage of the external device; and
an external housing securable at a location in proximity to the external device to protect the unattended POS device from environmental conditions and vandal attacks.

2. The POS device of claim 1, wherein the payment device comprises one or more of:
a card reader;
a coin discriminator;
an NFC reader; and
functionality for determining payment from a received code.

3. The POS device of claim 1, wherein the external interface comprises a physical connector for establishing a wired connection to the external device.

4. The POS device of claim 3, wherein the physical connector provides a data channel.

5. The POS device of claim 3, wherein the physical connector provides a power connection.

6. The POS device of claim 5, wherein the power component receives power from the external device over the power connection of the physical connector.

7. The POS device of claim 5, wherein the external device receives power from the POS device over the power connection of the physical connector.

8. The POS device of claim 7, wherein the power component comprises a battery housed within external housing.

9. The POS device of claim 8, further comprising a solar panel for recharging the battery.

10. The POS device of claim 1, wherein the control functionality allows the POS device to control a plurality of external devices.

11. The POS device of claim 10, wherein the plurality of external devices are arranged for use by different users simultaneously.

12. The POS device of claim 10, wherein the plurality of external devices are arranged for use by a single user.

13. The POS device of claim 1, wherein the external device comprises one or more of:
an air pressure device;
a vacuum device;
a charging device;
a car wash device;
an electric vehicle charging device or supply equipment;
a potable water dispenser device;
a windshield washer fluid dispenser device;
a newspaper dispenser device;
a lighting control device; and
a sports facilities control device.

14. The POS device of claim 1, wherein the keypad comprises one or more of:
an alpha-numeric keypad;
a six button keypad; and
a four button keypad.

15. The POS device of claim 1, wherein the display comprises a touch screen display.

16. The POS device of claim 15, wherein the keypad comprises a keypad screen displayed on the touch screen display.

17. The POS device of claim 2, wherein the external interface comprises a physical connector for establishing a wired connection to the external device.

18. The POS device of claim 4, wherein the physical connector provides a power connection.

19. The POS device of claim 2, wherein the control functionality allows the POS device to control a plurality of external devices.

20. The POS device of claim 3, wherein the control functionality allows the POS device to control a plurality of external devices.
